(19) United States
(12) Patent Application Publication
(10) Pub. No.: US 2025/0388448 A1
(43) Pub. Date: Dec. 25, 2025

(54) METHODS, SYSTEMS, AND DEVICES FOR AGITATION OF BEVERAGE INGREDIENTS IN BEVERAGE INGREDIENT CONTAINERS

(71) Applicant: BOTRISTA, INC., San Francisco, CA (US)

(72) Inventor: Wu-Chou KUO, San Francisco, CA (US)

(21) Appl. No.: 18/954,369

(22) Filed: Nov. 20, 2024

Related U.S. Application Data
(60) Provisional application No. 63/600,955, filed on Nov. 20, 2023.
(60) Provisional application No. 63/661,669, filed on Jun. 19, 2024.

(51) Int. Cl. B67D 1/00

(52) U.S. Cl. CPC B67D 1/0021; B67D 1/0078; B67D 1/0081

(57) ABSTRACT

Methods, systems, and devices for the agitation of beverage ingredients in beverage ingredient containers are disclosed. In some embodiments, an agitation system includes an ingredient tube assembly comprising a two-way valve, a reversible pump, and a connector tube connecting the valve to the pump. The valve is configured to couple the tube assembly to a beverage ingredient container and to allow beverage ingredient to flow in a forward or reverse direction. The reversible pump drives the flow of the beverage ingredient through the tube assembly. The system includes a controller, which controls operation of the tube assembly components. The ingredient tube assembly is configured to draw a portion of the beverage ingredient from the container into the tube assembly and subsequently discharge this portion back into the container using the reversible pump.

### CROSS-REFERENCE TO RELATED APPLICATIONS

The present application claims priority to U.S. Provisional Patent Application No. 63/661,669, titled “SYSTEMS AND METHODS FOR DRINK AUTOMATION,” filed Jun. 19, 2024, the entirety of which is incorporated herein by reference.

### TECHNICAL FIELD

The present technology is generally directed to beverage dispensing systems and, more specifically, to mixing and/or agitating beverage ingredients used in beverage dispensing systems.

### BACKGROUND

Freshly made beverages are typically more desirable to consumers than factory-produced, canned, or bottled beverages. For example, freshly made beverages can have superior taste, freshness, and/or customizability in the ingredients used in the beverage. Accordingly, restaurants, cafés, coffee shops, and/or other beverage vendors prefer to offer a menu of freshly made beverages. However, producing freshly made beverages often requires ingredients that include a large amount of pulp and/or particles (for example, fresh juices) or are otherwise viscous. This creates a number of challenges for the beverage industry, such as maintaining consistent beverage quality and flavor profile, particularly when crafting a large number (and/or large volume) of fresh beverages.

### BRIEF DESCRIPTION OF THE DRAWINGS

FIG. 1 is a schematic block diagram of a beverage system configured in accordance with embodiments of the present technology.

FIGS. 2A-2C illustrate an agitation system in accordance with some embodiments of the present technology.

FIGS. 3A and 3B illustrate an agitation system in accordance with some embodiments of the present technology.

FIG. 4 is a flowchart illustrating a method of agitating beverage ingredients in a beverage ingredient container in accordance with some embodiments of the present technology.

FIG. 5 is a block diagram illustrating an overview of devices on which some implementations can operate.

FIG. 6 is a block diagram illustrating an overview of an environment in which some implementations can operate.

FIG. 7 is a block diagram illustrating components that, in some implementations, can be used in a system employing the disclosed document.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### Overview

The present technology provides methods, systems, and devices for the agitation of beverage ingredients contained within beverage containers used with beverage dispensing systems. For example, the present technology discloses systems and methods for agitating and/or maintaining adequate mixing of a bag-in-box (BiB) ingredient container connected to a beverage dispensing machine. In some embodiments, the agitation system includes an ingredient tube assembly comprising a two-way valve, a reversible pump, and a connector tube connecting the valve to the pump. The valve is configured to couple the tube assembly to the container and to allow a beverage ingredient to flow in a forward or reverse direction (that is, from the container to the tube assembly and back from the tube assembly to the container). The reversible pump drives the flow of the beverage ingredient through the tube assembly (e.g., in the forward or reverse direction). The system includes a controller (e.g., a processor and memory), which controls operation of the tube assembly components. For example, the controller can cause the ingredient tube assembly to draw a portion of the beverage ingredient from the container into the tube assembly (e.g., into the volumetric space of the components of the tube assembly) and subsequently discharge this portion back into the container using the reversible pump. This process of drawing in and discharging ensures that the beverage ingredient in the container is thoroughly mixed.

When a liquid beverage ingredient and/or beverage with particles (e.g., pulp, fine solids, grains, fibers, etc.) is stored inside a container and/or bag-in-box (BiB), the particles tend to settle at the bottom of the package over time. Dispensing the ingredient from an unagitated package can result in unbalanced ingredient quality. For example, the bottom layer of the package becomes more concentrated, containing more flavor and particles, while the upper layer becomes less concentrated with fewer particles. Over time, dispensing from such a container causes the first few dispensed drinks to taste stronger with a more pronounced mouthfeel, while subsequent drinks exhibit less flavor intensity. The present technology addresses these issues by providing methods, systems, and devices that mix the ingredients in the container to provide consistent flavor quality, ensuring that each serving maintains the desired taste profile. The present technology can be integrated with many types of beverage dispensing systems, meaning it can agitate ingredients without the need for additional complex parts/components, expanding accessibility with minimal additional maintenance requirements. Additionally, the present technology is capable of customizable agitation of beverage ingredients based on the type/parameters of the ingredient, resulting in efficient mixing. Furthermore, the system can effectively agitate the ingredients even when the container, such as a bag, deforms to a smaller size, ensuring continuous and uniform mixing regardless of the container's condition.

In some embodiments, the beverage ingredient agitation system comprises a beverage ingredient container including a volume of at least one beverage ingredient. The system includes an ingredient tube assembly with a two-way valve that couples the ingredient tube assembly to the beverage ingredient container. This valve is configured to accommodate beverage ingredient flow from the container to the tube assembly and vice versa. The system also features a reversible pump configured to drive the beverage ingredient flow through the ingredient tube assembly and a tube coupling the two-way valve and the reversible pump. A processor and a memory are included, with the memory containing instructions that, when executed by the processor, cause the ingredient tube assembly to draw in a first portion of the volume of the beverage ingredient from the container and discharge it back into the container via the reversible pump.

In some embodiments, the system further comprises a first fluid reservoir configured to receive a second portion of the volume of the beverage ingredient from the container. The memory includes instructions that, when executed by the processor, cause the ingredient tube assembly to draw in the second portion of the volume of the beverage ingredient from the container and discharge it back into the container via the reversible pump. In some embodiments, the second portion of the volume of the beverage ingredient is greater than the first portion.

In some embodiments, the reversible pump is positioned between the first fluid reservoir and the beverage ingredient container and the first fluid reservoir is positioned at a greater height relative to ground than the reversible pump, such that the second portion of the volume of the beverage ingredient contained in the first fluid reservoir flows through the reversible pump and the two-way valve when the ingredient tube assembly is discharging into the beverage ingredient container.

In some embodiments, the first fluid reservoir comprises a flexible material and is configured to exert a force on the first and second portions of the volume of the beverage ingredient when compressed.

In some embodiments, the system further comprises a second fluid reservoir configured to receive a third portion of the volume of the beverage ingredient from the container. The memory includes instructions that, when executed by the processor, cause the ingredient tube assembly to draw in the third portion of the volume of the beverage ingredient from the container and discharge it back into the container via the reversible pump.

In some embodiments, the memory includes instructions that, when executed by the processor, cause the ingredient tube assembly to receive a signal corresponding to a dispense order for the beverage ingredient contained in the container. In response to the received signal, the processor executes instructions to discharge the first portion of the volume of the beverage ingredient back into the container via the reversible pump.

In some embodiments, the memory includes instructions that cause the ingredient tube assembly to periodically draw in and discharge the first portion of the volume of the beverage ingredient. This periodic action ensures continuous agitation and prevents the beverage ingredient from settling or separating over time.

In some embodiments, the memory includes instructions that cause the ingredient tube assembly to determine one or more parameters of the beverage ingredient and draw in and discharge the first portion of the volume of the beverage ingredient based on these parameters. In some embodiments, the parameters of the beverage ingredient include one or more of the following: viscosity, temperature, fruit type, fruit particle concentration, pulp concentration, dairy type, dairy concentration, syrup type, syrup concentration, and chemical composition. In some embodiments, the memory includes instructions that cause the ingredient tube assembly to modify the pump speed of the reversible pump based on the one or more parameters. In some embodiments, the memory includes instructions that cause the ingredient tube assembly to modify the volume of the first portion based on the one or more parameters.

In some embodiments, the present technology provides a method of agitating a volume of beverage ingredient in a beverage ingredient container. The method comprises drawing a first portion of the volume of the beverage ingredient contained in the container into a tube assembly. The tube assembly includes a two-way valve, a reversible pump, and a tube coupling the two-way valve to the reversible pump. The method further includes discharging, via the reversible pump, the first portion of the volume of the beverage ingredient into the container.

In some embodiments, the method further comprises drawing in a second portion of the volume of the beverage ingredient from the container into a first reservoir of the tube assembly contemporaneously with drawing in the first portion and discharging, via the reversible pump, the second portion of the volume of the beverage ingredient into the container contemporaneously with discharging the first portion. In some embodiments, the method further comprises drawing the first portion of the volume of the beverage ingredient into the tube assembly before drawing the second portion of beverage ingredient into the first reservoir. In some embodiments, the method further comprises discharging the first portion from the tube assembly before discharging the second portion from the first reservoir. In some embodiments, the method further comprises drawing the second portion into the first reservoir before the first portion is drawn into the tube assembly, and discharging the second portion from the first reservoir before discharging the first portion from the tube assembly. One skilled in the art will appreciate that the order of drawing in the first and second portions and the order of discharging the first and second portions can be readily varied to accommodate, for example, different physical arrangements of the tube assembly and first reservoir.

In some embodiments, the method further comprises receiving a signal corresponding to an order to dispense the beverage ingredient contained in the container and discharging, in response to the received signal, via the reversible pump, the first portion of the volume of the beverage ingredient into the container.

In some embodiments, the method further comprises periodically drawing in and discharging the first portion of the volume of the beverage ingredient.

In some embodiments, the method further comprises determining one or more parameters of the beverage ingredient, drawing in the first portion of the volume of the beverage ingredient based on the one or more parameters, and discharging the first portion of the volume of the beverage ingredient based on the one or more parameters.

In some embodiments, the method further comprises modifying the pump speed of the reversible pump based on the one or more parameters and modifying the volume of the first portion based on the one or more parameters.

### A. EMBODIMENTS OF BEVERAGE SYSTEMS

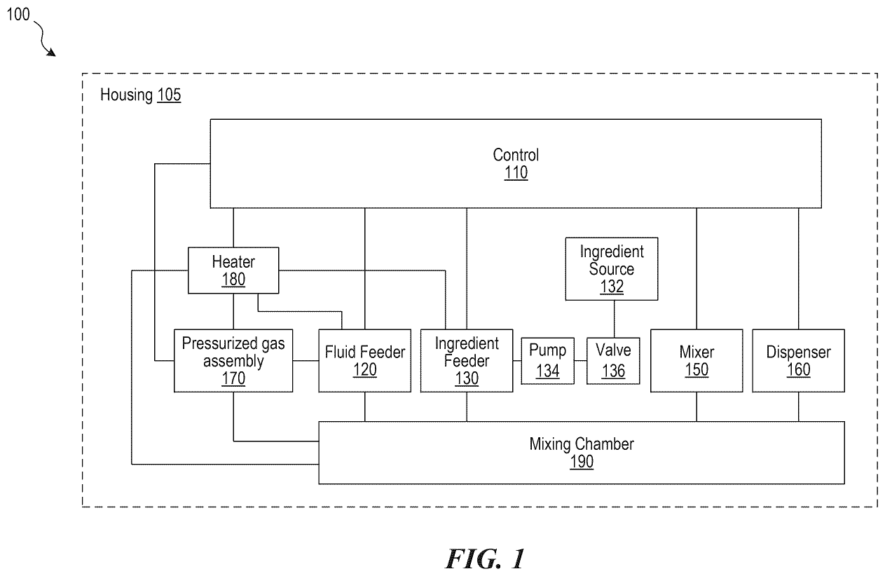

FIG. 1 is a schematic block diagram of a beverage system 100 configured in accordance with embodiments of the present technology. The system 100 can include a control 110, a fluid feeder 120, an ingredient feeder 130, a cleaning solution feeder (not pictured), a mixer 150, a dispenser 160, a pressurized gas assembly 170, a heater 180, and a mixing chamber 190. In some embodiments, the system 100 may include a drainage assembly (not pictured). At least some of these components 110-190 may be accommodated within a housing 105. As discussed further herein, the system 100 can be operated to prepare a beverage. In FIG. 1, some of the components are linked together by lines, indicating that those components can be operably coupled to one another. However, in some embodiments, those components may not be operably coupled as such.

The control 110 may be configured to interface with a user and/or coordinate the operation of the system 100. The control 110 may include one or more hardware and software components for controlling operation of the system 100. For example, the control 110 can include one or more processors (e.g., central processing unit(s) (CPU(s)), graphics processing unit(s) (GPU(s)), holographic processing unit(s) (HPU(s)), etc.) and memory (e.g., volatile storage, non-volatile storage) for storing instructions to be executed by the one or more processors. The control 110 may include or be in the form of one or more controllers, one or more controller circuits, or the like, or a combination thereof. Examples of controllers may include a microcontroller, a programmable logic controller (PLC), a digital signal controller (DSC), a motor controller, a temperature controller, a valve controller, or the like, or a combination thereof. In some embodiments, the control 110 may include a control circuit formed by a plurality of controllers.

The control 110 may include or function as a central command unit, interfacing with a user through input signals. The control 110 may interpret user input and translate it into actionable instructions for the system components. For instance, when a user selects a beverage option, the control 110 may process this input and send appropriate signals to the fluid feeder 120, the ingredient feeder 130, the mixer 150, and the dispenser 160, causing the fluid feeder 120 and the ingredient feeder 130 to discharge appropriate amounts of fluid and one or more target ingredients (also referred to as beverage ingredients or liquid beverage ingredients), causing the mixer 150 to mix them in the mixing chamber 190, and causing the dispenser 160 to allow the resulting mixture to be dispensed from the mixing chamber 190 to a cup (e.g., a blender cup for subsequent blending/mixing, an individual serving cup, etc.), thereby producing the beverage of choice automatically.

The control 110 can operate autonomously by utilizing embedded algorithms. Exemplary algorithms can include predetermined beverage production schedules to warm up and peak/off-peak time management, beverage recipes (including, e.g., respective amounts of a fluid and one or more target ingredients, dispensing parameters, temperature, or the like, or a combination thereof), predictive algorithms to forecast demand based on historical data, cleaning schedules and/or protocols to maintain hygiene standards, or the like, or a combination thereof.

The signals generated by the controller or control circuit may be tailored for specific actions within the system 100. For instance:

Valve Control: The control 110 can generate signals to open or close a controllable valve regulating the flow of water or other fluids through the system 100. This may allow the right amount of fluid to be dispensed at the right time.

Actuator Control: Signals can be generated to control actuators or motors responsible for moving components of the system 100. This may involve driving the mixer 150 to perform mixing, moving the dispenser 160 to allow or block dispensing from the mixing chamber 190, etc.

Pump Operation: The control 110 can modulate the operation of pumps to adjust the flow rate and/or pressure of a fluid, a gas, a mixture, etc., maintaining consistency and quality in beverage production, cleaning, etc.

Temperature Regulation: The control 110 can manage heaters or coolers within the system 100, sending signals to adjust the temperature of a fluid to a desired level, ensuring that beverages are served at a desired temperature.

The fluid feeder 120 may be configured to hold and/or discharge a fluid. The fluid may be used to make a beverage or clean at least a portion of the system 100. In some embodiments, the fluid may be water, e.g., tap water, filter water, etc. The fluid feeder 120 may include a fluid channel where a fluid is discharged into the mixing chamber 190. The fluid channel may be coupled to a fluid supply source. The fluid supply source may include a tank, a container, or another storage component for storing the fluid. The fluid supply source may be part of the fluid feeder 120. For example, the fluid supply source may include a fluid tank positioned within or outside the housing 105. The fluid supply source may be an external source (e.g., tap water) connected to the fluid feeder 120 via a tube. The fluid supply source may be connected to the fluid channel via a tube. The fluid feeder 120 may include a pump and/or a valve (e.g., a metering valve, a solenoid valve, or another type of controllable valve) to facilitate delivering the fluid from the fluid supply source to the fluid channel for discharging into the mixing chamber 190. At least one of the pump or the valves may be controlled, based on signals (e.g., signals from the control 110), to regulate when and/or how much fluid is fed to the fluid channel or to the mixing chamber 190 via the fluid channel. A fluid may flow in only one direction, from the fluid supply source toward the mixing chamber 190, not in the reverse direction.

The ingredient feeder 130 may be configured to hold and/or discharge one or more ingredients. The ingredient(s) may be used to make a beverage using the system 100. The ingredient feeder 130 may include a tank, a container, or one or more other storage components for storing one or more ingredients to be used for producing a beverage. In some embodiments, the ingredient feeder 130 is configured to receive one or more beverage ingredients from a beverage ingredient package, such as a bag-in-box (BiB) container. Example ingredients include syrups (e.g., caramel syrup, mocha syrup), whipped cream, dairy and non-dairy milk alternatives (e.g., whole milk, skim milk, half-and-half, heavy cream, soy milk, almond milk, coconut milk, etc.), fruit purees or juices (e.g., mango puree/juice, strawberry puree/juice, peach puree/juice, pineapple puree/juice, apple puree/juice, orange puree/juice, etc.), and/or other fluid-based ingredients. A fruit juice may include pulp or not. In some embodiments, the ingredient feeder 130 may include multiple isolated compartments for separately storing multiple ingredients. The ingredient feeder 130 may further include one or more ingredient nozzles for discharging one or more ingredients into the mixing chamber 190. An ingredient nozzle may be coupled to an ingredient container via a tube. The ingredient feeder 130 may include a pump 134 and/or a valve 136 to facilitate delivering an ingredient from an ingredient source 132 to the ingredient nozzle for discharging into the mixing chamber 190. At least one of the pump 134 and/or the valve 136 may be controlled, based on signals (e.g., signals from the control 110), to regulate when and/or how much an ingredient is fed to the mixing chamber 190 via a corresponding ingredient nozzle. The ingredient feeder 130 may include a nozzle plate where one or more ingredient nozzles are supported. The nozzle plate may be supported on the mixing chamber 190. An ingredient may flow in only one direction, from an ingredient source 132 toward the mixing chamber 190, not in the reverse direction. For example, an ingredient valve 136 may be a one-way valve. In some embodiments, an ingredient valve 136 may be a two-way valve. Additional descriptions may be found elsewhere in the present document.

The mixing chamber 190 may be configured to receive content from one or multiple sources. The mixing chamber 190 may receive content from one or more sources including the fluid feeder 120, the ingredient feeder 130, and the cleaning solution feeder. The mixing chamber 190 may be positioned along a vertical direction below, at substantially the same level as, or above at least a portion of the fluid feeder 120, the ingredient feeder 130, and/or the cleaning solution feeder. For example, the fluid feeder 120 may include or be coupled to a fluid source to receive a fluid; the mixing chamber 190 may be positioned below at least a portion of the fluid source (along the vertical direction, allowing fluid to flow from the fluid source into the mixing chamber 190 driven at least in part by gravity). As another example, the mixing chamber 190 may be positioned substantially at the same level as or above at least a portion of the fluid source along the vertical direction, allowing fluid to flow from the fluid source into the mixing chamber 190 driven at least in part by a pump.

The mixing chamber 190 may include a dispensing opening through which the content may be dispensed, e.g., to a user's cup, a blender/blending cup, a drainage assembly, a drainage container, etc. The mixing chamber 190 may provide a space where the content can be mixed before being dispensed. For example, the mixing chamber 190 may receive content including the fluid from the fluid feeder 120 and one or more ingredients from the ingredient feeder 130, the content may be mixed in the mixing chamber 190 using the mixer 150 to form a mixture, and the mixture may be dispensed from the mixing chamber 190 via the dispensing opening. As another example, the mixing chamber 190 may receive content (e.g., the fluid) and allow the content to be dispensed from the mixing chamber 190 without being mixed with another substance (e.g., a different fluid, a cleaning solution, or an ingredient). The mixing chamber 190 may include one or more food-grade materials. Suitable materials for the mixing chamber 190 may include stainless steel, silicone, plastic, or rubber, depending on the durability and compatibility with the content of the mixing chamber 190.

The mixer 150 may be configured to mix content in the mixing chamber 190. The content may include, e.g., a fluid (e.g., the fluid from the fluid feeder 120), one or more other ingredients (e.g., one or more ingredients from the ingredient feeder 130), or one or more cleaning solutions (e.g., one or more ingredients from the cleaning solution feeder). In use, the mixer 150 may be at least partially immersed in the content (including a liquid medium). For example, the mixer 150 may mix a fluid (e.g., from the fluid feeder 120) with one or more ingredients in the mixing chamber 190 as part of the process of producing a beverage of choice. As another example, the mixer 150 may mix a fluid (e.g., from the fluid feeder 120) with one or more cleaning solutions in the mixing chamber 190 as part of a cleaning process. The mixer 150 may include a mechanical stirrer, a vibration stirrer, an ultrasonic transducer, or a combination thereof. For example, the mixer 150 may include a mechanical stirrer coupled to a rotating motor, thereby performing mixing by rotating. As another example, the mixer 150 may include a transducer coupled to a pulse generator, thereby performing mixing by ultrasonic vibration. The rotating motor or the pulse generator may be controlled based on signals from, e.g., the control 110. In some embodiments, the mixer 150 may be detachable from its actuator or transducer for cleaning or replacement. In some embodiments, the coupling between the mixer 150 and the actuator may not be detachable. For example, the system 100 is configured with automated cleaning features and it is unnecessary to remove the mixer 150 for cleaning. The mixer 150 may include one or more food-grade materials. Suitable materials for the mixer 150 may include stainless steel, aluminum, food-grade plastic, silicone, fiberglass, rubber, or the like, or an alloy, or a combination thereof, depending on one or more factors including safety, durability, weight, compatibility with the content of the mixing chamber 190, etc.

The dispenser 160 may be configured to control dispensing from the mixing chamber 190 via the dispensing opening. In some embodiments, the dispenser 160 may be moveable to adjust the extent to which the dispensing opening is available for dispensing. The dispenser 160 may be coupled to an actuator controlled based on signals from, e.g., the control 110. Merely by way of example, the dispenser 160 may partially block or completely block the dispensing opening, thereby reducing or eliminating the flow exiting the mixing chamber 190 through the dispensing opening. The dispenser 160 may include a plug having a shape and size complementary to the dispensing opening of the mixing chamber 190. The dispenser 160 may include one or more food-grade materials. Suitable materials for the dispenser 160 may include a material including stainless steel, aluminum, food-grade plastic, silicone, fiberglass, rubber, or the like, or an alloy, or a combination thereof, depending on one or more factors including safety, durability, weight, compatibility with the content of the mixing chamber 190, etc.

The pressurized gas assembly 170 may be configured to provide pressurized gas. In some embodiments, the gas may include air. The pressurized gas assembly 170 may include a gas pump. The pressurized gas assembly 170 may provide pressurized gas into one or more portions of the system 100. For example, the pressurized gas assembly 170 may provide pressurized gas into the mixing chamber 190 to facilitate mixing of ingredients by performing aeration mixing. As another example, the pressurized gas assembly 170 may provide pressurized gas into the mixing chamber 190 to facilitate dispensing of content (e.g., a mixture) from the mixing chamber 190 into, e.g., a blender cup. As a further example, the pressurized gas assembly 170 may supply pressurized gas to the fluid channel or spray rim. This pressurized gas can either pressurize a fluid to enhance cleaning performance or, without mixing with water, blow-dry at least a portion of the system 100 for cleaning and/or storage purposes. The operation of the pressurized gas assembly 170 (e.g., a gas pump of the pressurized gas assembly 170) may be controlled based on signals from, e.g., the control 110.

In some embodiments, the pressurized gas assembly 170 may serve as a vacuum assembly configured to remove air from the mixing chamber 190. For example, through an opening on the nozzle plate, a gas pump in the pressurized gas assembly 170 may extract air from the mixing chamber 190 before ingredient(s) and/or fluid are added or mixed in the mixing chamber 190. This air extraction process may continue for a certain period (e.g., 10, 20, or 30 seconds) and/or until the air pressure in the mixing chamber 190 reaches a specified level. Reducing or minimizing air in the mixing chamber 190 during the mixing operation may slow down ingredient oxidation and/or reduce foam generation (e.g., when mixing a dairy product), thereby improving the quality of the produced beverage and/or simplifying the cleaning process. For instance, reducing foam during the blending process helps prevent dairy products from adhering to hard-to-clean corners, making the system 100 easier to clean.

The heater 180 may be configured to heat content and/or components of the system 100. In some embodiments, the heater 180 may be configured to heat a fluid, an ingredient, and/or a gas to facilitate the production of a warm or hot beverage of choice and/or to aid in the cleaning of the system. The operation of the heater 180 may be controlled based on signals from, e.g., the control 110.

In some embodiments, the housing 105 may prevent public access to the components of the system 100 positioned within the housing 105. For example, the ingredient feeder 130 may be located inside the housing 105 and inaccessible to the general public for safety, hygiene, and/or other considerations. As another example, the control 110 may be located inside the housing 105, making it inaccessible to the general public to prevent damage from environmental disturbances (e.g., spills, physical impacts) and to ensure reliable operation. The control 110 may interface with a user via a user interface (e.g., a touch screen) installed on the housing 105. There may be multiple compartments within the housing 105, each with different access-control mechanisms. For example, the housing 105 may include compartment 1 and compartment 2; access to compartment 1 may be lock or password protected, while access to compartment 2 may be granted upon request or combined with one or more other criteria. The ingredient feeder 130 is located within compartment 1 and is accessible only to authorized users (e.g., authorized staff of a restaurant or office). In contrast, the mixer 150 is accessible upon request, such as when a user requests to replace a stirrer suitable for preparing a selected beverage. In some embodiments, there may be multiple compartments within the housing 105 to achieve the desired separation between different components of the system 100. Examples of separation types include fluid separation, thermal separation, and physical separation for various considerations such as convenient cleaning, preventing cross-contamination, enhancing safety, ensuring proper insulation, and optimizing component performance. These separations may help maintain the integrity and efficiency of the system 100. In some embodiments, the housing 105 of the system 100 may be made from suitable materials such as stainless steel, aluminum, high-density polyethylene (HDPE), polycarbonate, etc. These materials are chosen for their durability, case of cleaning, and resistance to corrosion. The system 100 may be placed in various locations, including a restaurant, a break room in an office, or a shopping mall, allowing it to meet the demands of different environments. Components of the system 100 may be arranged within or in a vicinity of the housing 105 based on one or more considerations including the vertical positioning for optimal fluid flow, the proximity for efficient operation and maintenance, potential system expansion, case of access for cleaning and maintenance (e.g., refilling ingredients, cleaning solutions, etc.), or the like, or a combination thereof.

The ingredient feeder 130 may include or be connected to one or more ingredient sources 132 to receive one or more ingredients for producing a beverage. The ingredient source 132 may include or be connected to one or more containers holding ingredient(s) or external ingredient supply sources (e.g., a bag-in-box (BiB) unit). Example ingredients include syrups (e.g., caramel syrup, mocha syrup), whipped cream, dairy and non-dairy milk alternatives (e.g., whole milk, skim milk, half-and-half, heavy cream, soy milk, almond milk, coconut milk, etc.), fruit purees or juices (e.g., mango puree/juice, strawberry puree/juice, peach puree/juice, pineapple puree/juice, apple puree/juice, orange puree/juice, etc.), sparkling water, and/or other fluid-based ingredients. A fruit juice may include pulp or not. In some embodiments, the ingredient sources 132 may include multiple isolated compartments for separately storing multiple ingredients.

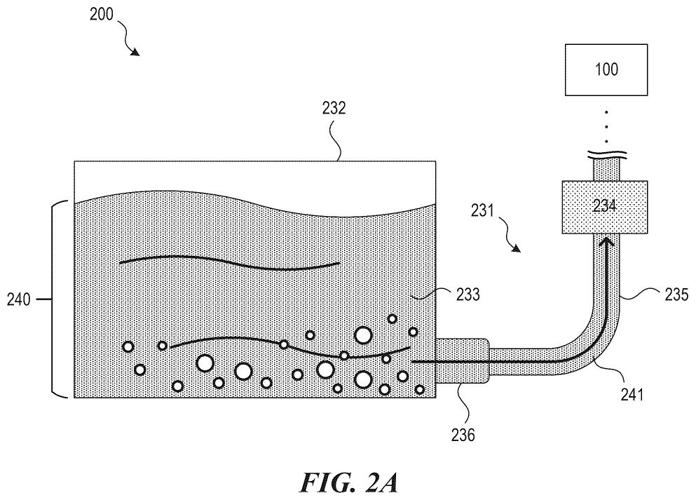

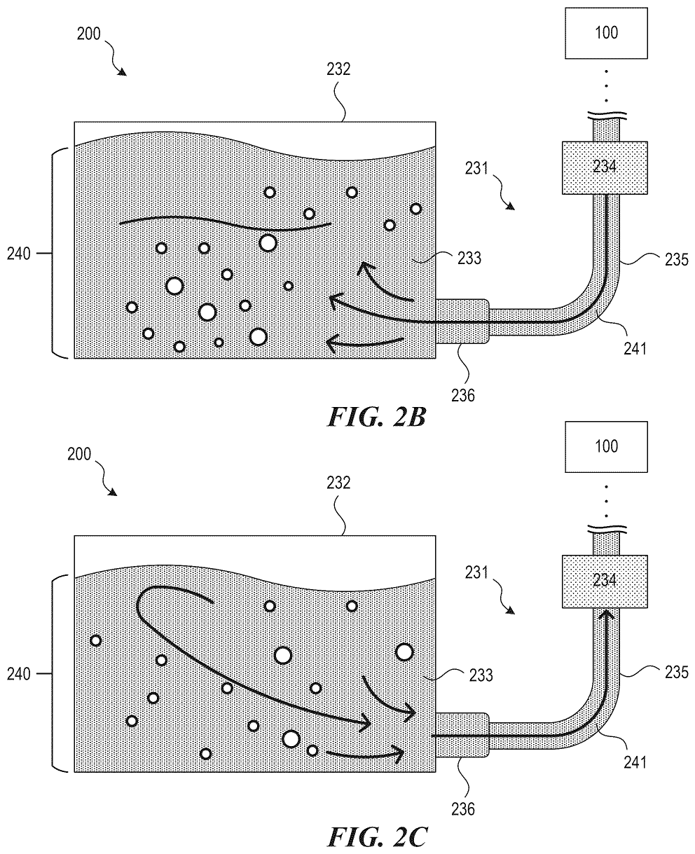

The ingredient feeder 130 may include one or more ingredient pathways to guide ingredients from the ingredient sources 132 to the mixing chamber 190. An ingredient pathway may include an ingredient tube and/or ingredient tube assembly, discussed further with reference to FIGS. 2A-4. The ingredient pathway may facilitate a controllable delivery of an ingredient from an ingredient source 132 to the mixing chamber 190, such that one or more parameters of the flow of an ingredient may be regulated as to which, when, and/or how much an ingredient is fed to the mixing chamber 190. Examples of these parameters may include the amount, pressure, timing of the ingredient flow, or a combination thereof. The control may be achieved using at least one of a pump 134 (e.g., a reversible pump, discussed further with reference to FIGS. 2A-2C), a controllable valve 136 (e.g., a two-way connecting valve, discussed further with reference to FIG. 2A-2C), or the like, or a combination thereof. The operation of the pump 134 may be controlled by a controller or control circuit. The controllable valve 136 may include a metering valve, a solenoid valve, or the like. The operation of the controllable valve 136 may be controlled by a controller or control circuit. In some embodiments, ingredient pathways connected to different ingredient sources 132 may have different configurations depending on one or more parameters of the ingredients to be delivered through the respective ingredient pathways. Examples of such ingredient parameters may include viscosity, temperature stability, particulate content, or the like, or a combination thereof.

An ingredient pathway may guide one or more ingredients from the ingredient sources 132 for discharging into the mixing chamber 190. For example, one ingredient pathway (including an ingredient tube assembly, ingredient tube, a pump 134, and/or a valve 136) may be coupled to a single ingredient source 132. This configuration may avoid contamination of the ingredient pathway, or a portion thereof, and/or prevent interference between different ingredients in beverage preparation. As another example, one ingredient pathway can be coupled to multiple ingredient sources 132. This can be achieved by using a multi-way valve to connect multiple ingredient sources 132 to a single ingredient pathway. To reduce or minimize interference between ingredients sharing a same ingredient pathway (e.g., when different ingredients are used in making various beverages at different times or a same beverage) and/or achieve effective ingredient delivery, the ingredients may have one or more similar characteristics, such as tastes, colors, flow properties (e.g., viscosity), allergy risks, or the like, or a combination thereof.

The ingredient feeder 130 may include one or more ingredient nozzles for discharging one or more ingredients into the mixing chamber 190. An ingredient nozzle may be coupled to an ingredient source 132 via an ingredient pathway. An ingredient nozzle may be positioned substantially above the opening of the mixing chamber 190 defined by its rim.

An ingredient signal (e.g., an ingredient signal of a first set of signals, a second ingredient signal of a second set of signals) may be configured to cause the ingredient feeder 130 to discharge a specific amount of a target ingredient into the mixing chamber 190. The ingredient signal may include signals for operating components involved in discharging the target ingredient. For example, the ingredient signal may include a signal for the pump 134 and/or a signal for the valve 136, causing the specified amount of a target ingredient (e.g., an ingredient from an ingredient source 132) to be discharged with one or more desired parameters into the mixing chamber 190 via, e.g., the ingredient nozzle. Examples of relevant parameters may include flow rate, pressure, temperature, or a combination thereof. For instance, the specified amount of the target ingredient may be discharged into the mixing chamber 190 with a controlled flow rate to facilitate mixing with other content in the mixing chamber 190.

### B. SPECIFIC EXAMPLES OF AGITATION OF BEVERAGE INGREDIENT IN BEVERAGE INGREDIENT CONTAINERS IN ACCORDANCE WITH EMBODIMENTS OF THE PRESENT TECHNOLOGY

FIGS. 2A-2C illustrate an agitation system 200 in accordance with some embodiments of the present technology. FIG. 2A illustrates the agitation system 200 drawing a first volume (also referred to as a portion) of beverage ingredient 233 into an ingredient tube assembly 231 from a beverage ingredient source 232 (also referred to as a beverage ingredient container). FIG. 2B illustrates agitation system 200 discharging the first volume of beverage ingredient 233 drawn into the ingredient tube assembly 231 back into the beverage ingredient source 232. FIG. 2C illustrates agitation system 200 drawing an additional (e.g., a second) volume of beverage ingredient 233 into the ingredient tube assembly 231 following the discharge. In some embodiments, the agitation system 200 includes features that are generally similar/identical to features of the beverage system 100 of FIG. 1. Accordingly, similar reference numbers refer to similar components.

Referring to FIGS. 2A-2C together, in the present embodiments, agitation system 200 comprises a beverage ingredient container 232 containing an initial volume 240 of one or more beverage ingredients 233, and an ingredient tube assembly 231. The ingredient tube assembly 231 includes one or more reversible pumps 234 (e.g., gear pumps, centrifugal pumps, diaphragm pumps, screw pumps, etc.), a two-way connecting valve 236 configured to couple the ingredient tube assembly 231 to the ingredient container 232, and a connector tube 235 (also referred to as an ingredient tube) configured to couple the valve 236 to the reversible pump 234. The two-way valve 236 is configured to accommodate flow of beverage ingredient 233 from the beverage container 232 into the tube assembly 231 (e.g., into the volumetric space of the components of the tube assembly 231, such as the valve 236, the connector tube 235, and the reversible pump 234). The two-way valve 236 is further configured to accommodate flow of beverage ingredient 233 from the tube assembly 231 into the beverage container 232. The reversible pump 234 is configured to drive/pump the flow of beverage ingredient 233 throughout the agitation system 200. For example, the reversible pump 234 is configured to drive the flow of beverage ingredient 233 from the tube assembly 231 into the beverage ingredient container 232 via the two-way valve 236. The reversible pump 234 is further configured to drive the flow of beverage ingredient 233 from the beverage ingredient container 232 into the tube assembly 231. The reversible pump 234 is further configured to provide beverage ingredients 233 to additional components of a beverage dispensing system 100 (e.g., the ingredient feeder 130, mixing chamber 190, etc.).

As shown in FIGS. 2A and 2C, in some embodiments, the ingredient tube assembly 231 is configured to draw in a first portion 241 of the initial volume 240 of the beverage ingredients 233 contained in the beverage ingredient container 232. In some embodiments, the ingredient tube assembly 231 draws in the first portion 241 via operation of the reversible pump 234. In some embodiments, the first portion 241 is drawn in via other motive forces and/or operations, such as when initially priming the agitation system 200 and/or downstream components of the beverage dispensing system 100. For example, manual filling of a reservoir (not pictured) and/or drawing a vacuum on the ingredient container 232 can draw in the first portion 241 to the tube assembly 231.

As shown in FIG. 2B, in some embodiments, the ingredient tube assembly 231 is configured to discharge the drawn-in first portion 241 into the beverage ingredient container 232. In some embodiments, the reversible pump 234 provides the driving force for discharging the first portion 241. In some embodiments, the first portion 241 is discharged into the beverage ingredient container 232 at least in part via gravity (e.g., when a very low amount of the beverage ingredient 233 remains in the beverage ingredient container 232).

In some embodiments, the agitation system 200 is configured to receive a signal corresponding to an order to dispense the beverage ingredients 233 contained in the beverage ingredient container 232. For example, when a user selects “orange juice” on a touchscreen interface, the system 200 receives this signal. In response to the received signal, the system discharges, via the reversible pump 234, the first portion 241 of the volume 240 of the beverage ingredients 233 into the beverage ingredient container 232. This ensures that the orange juice is well-mixed before dispensing.

In some embodiments, the agitation system 200 is configured to periodically draw the first portion 241 into the ingredient tube assembly 231 and discharge the first portion 241 into the beverage ingredient container 232. For example, the system 200 can be configured to cycle (e.g., draw in and discharge) three ounces of orange juice from an orange juice BiB every 30 minutes to maintain uniform pulp/particle consistency.

In some embodiments, the agitation system 200 is configured to determine one or more parameters of the beverage ingredients 233 and draw in and discharge the first portion 241 of the volume 240 of the beverage ingredients 233 based on these parameters. For example, the system 200 can receive an indication (e.g., from user input) that a BiB containing high-pulp orange juice is connected to the agitation system 200. In response to the indication, the agitation system 200 can retrieve pre-programmed parameter values for high-pulp orange juice from a look-up table stored in a memory of the agitation system 200. Based on the retrieved parameter values for high-pulp orange juice, the system 200 can increase the draw-in/discharge cycle frequency (e.g., increasing the rate from every 30 minutes to every 15 minutes), the size of the first portion 241 (e.g., increasing the volume of the first portion 241 from three ounces to five ounces), intensity of agitation (e.g., increasing reversible pump 234 discharge speed and/or draw-in speed). In some embodiments, the parameters of the beverage ingredients 233 are retrieved via scanning/reading a retrieval feature associated with the beverage ingredient container 232 and/or beverage ingredients 233, such as a QR code or barcode.

In some embodiments, the size (i.e., volume) of the first portion 241 is determined based on a run time of the reversible pump 234. For example, for high-pulp orange juice, a pump 234 run time of three seconds (e.g., in a slow speed mode of operation) can be associated with five ounces of juice drawn in and/or discharged. In some embodiments, a run time of the pump 234 is determined independent of determining a size of the first portion 241 (e.g., independent of determining volume of the first portion 241). That is, the agitation system 200 is configured to determine a run time for the reversible pump 234 in addition to determining one or more parameters of the beverage ingredients 233. In some embodiments, the agitation system 200 is configured to draw in and discharge the first portion 241 of the volume 240 of the beverage ingredients 233 based on the one or more parameters and on the determined run time of the reversible pump 234. In some embodiments, the agitation system 200 is configured to draw in and discharge the first portion 241 based only on the run time of the reversible pump 234 (i.e., independently of the one or more parameters of the beverage ingredients 233).

In some embodiments, the agitation system 200 is configured to determine one or more parameter values from one or more sensors and/or probes (not pictured, e.g., one or more temperature sensors, pressure sensors, etc.). For example, the agitation system 300 can reduce the cycle frequency in response to an elevated temperature value, which may indicate lower viscosity of the beverage ingredient 233 (and thus, less mixing required for the beverage ingredient 233). In some embodiments, pre-programmed parameter values can include viscosity, fruit type, fruit particle concentration, pulp concentration, dairy type, dairy concentration, syrup type, syrup concentration, chemical composition, and beverage ingredient brand, to name a few examples.

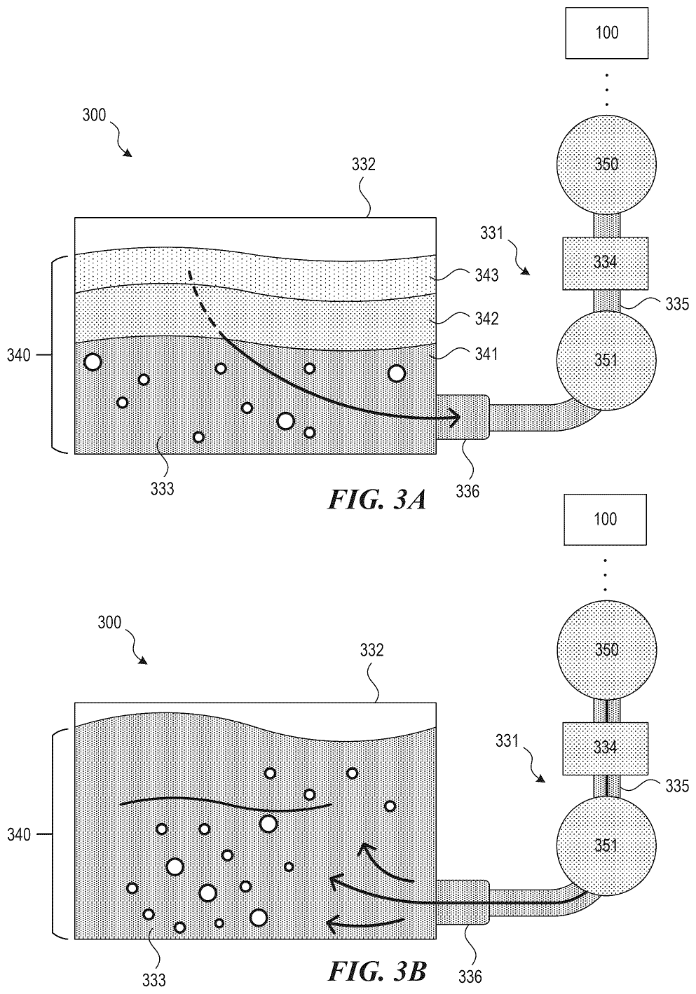

FIGS. 3A and 3B illustrate an agitation system 300 in accordance with some embodiments of the present technology. FIG. 3A illustrates the agitation system 300 drawing first, second, and third volumes (also referred to as portions) of beverage ingredient 333 into an ingredient tube assembly 331 from a beverage ingredient source 332. FIG. 3B illustrates agitation system 300 discharging the first, second, and third volumes of beverage ingredient 333 drawn into the ingredient tube assembly 331 back into the beverage ingredient source 332. In some embodiments, the agitation system 300 includes features that are generally similar/identical to features of the beverage system 100 of FIG. 1 and the agitation system 200 of FIGS. 2A-2C. Accordingly, similar reference numbers refer to similar components.

Referring to FIGS. 3A and 3B together, in the present embodiments, agitation system 300 comprises a beverage ingredient container 332 containing an initial volume 340 of one or more beverage ingredients 333, and an ingredient tube assembly 331. The ingredient tube assembly 331 includes one or more reversible pumps 334, a two-way connecting valve 336 configured to couple the ingredient tube assembly 331 to the ingredient container 332, and a connector tube 335 configured to couple the valve 336 to the reversible pump 334. The ingredient tube assembly 331 is configured to draw in and discharge a first portion 341 of the initial volume 340 of the beverage ingredient 333. For example, the volumetric space of the two-way valve 336, connector tube 335, and reversible pump 334 is configured to accommodate a first portion 341 of beverage ingredient(s) 333.

In some embodiments, the ingredient tube assembly 331 further includes a first fluid reservoir 350 configured to receive a second portion 342 of the volume 340 of the beverage ingredients 333 from the beverage ingredient container 332. The system 300 is configured to draw in and discharge the second portion 342 via the flow mechanisms described with reference to FIGS. 2A-2C (e.g., via one or more of pump 334 operation, gravity, drawing vacuum, etc.). The first reservoir 350 expands the amount of mixing achieved in the beverage ingredient container 332 by increasing the capacity of the ingredient tube assembly 331 to draw in and discharge greater volumes of beverage ingredient 333. For example, the addition of the first fluid reservoir 350 can increase the total volume of drawn-in and discharged beverage ingredient 333 from three ounces to thirty ounces, increasing mixing efficiency. In some embodiments, the second portion 342 is greater than the first portion 341. For example, the agitation system 300 can be configured to draw in a first portion 341 of five ounces of orange juice to the volumetric space of the internal components of the tube assembly 331 (excluding the first reservoir 350) and a second portion 342 of fifty ounces of orange juice to the first reservoir 350. In such an example, a total of fifty-five ounces of orange juice is cycled between the beverage ingredient container 332 and tube assembly 331.

In some embodiments, the reversible pump 334 is positioned between the first fluid reservoir 350 and the beverage ingredient container 332, and the first reservoir 350 is positioned at a greater height relative to ground than the reversible pump 334. In such a configuration, the second portion 342 of the volume 340 of the beverage ingredient 333 contained in the first fluid reservoir 350 provides a height-based pressure differential that increases line pressure throughout the ingredient tube assembly 331, passively enhancing the intensity of agitation of beverage ingredient 333 during discharge.

In some embodiments, the first fluid reservoir 350 comprises a flexible material, such as a plastic and/or rubber polymer. This flexibility is configured to exert a force on the first and second portions 341, 342 of the volume 340 of the beverage ingredient 333 in the tube assembly 331 such that these portions are at least partially driven into the beverage ingredient container 332 by compressing (e.g., squeezing) the first fluid reservoir 350. For instance, the first fluid reservoir 350 can be a flexible plastic polymer bladder, which, when squeezed, forces the fifty-five ounces of orange juice in the tube assembly 331 back into the container 332, aiding in the mixing process.

In some embodiments, the agitation system 300 further comprises a second fluid reservoir 351 configured to receive a third portion 343 of the volume 340 of the beverage ingredients 333 from the beverage ingredient container 332. The system 300 is configured to draw in the third portion 343 from the beverage ingredient container 332 and discharge this third portion 343 back into the beverage ingredient container 332. In some embodiments, one or more of the first and second fluid reservoirs 350, 351 comprise flexible materials. In some embodiments, one or more of the first and second fluid reservoirs 350, 351 comprise rigid materials (e.g., a hardened/non-deformable plastic).

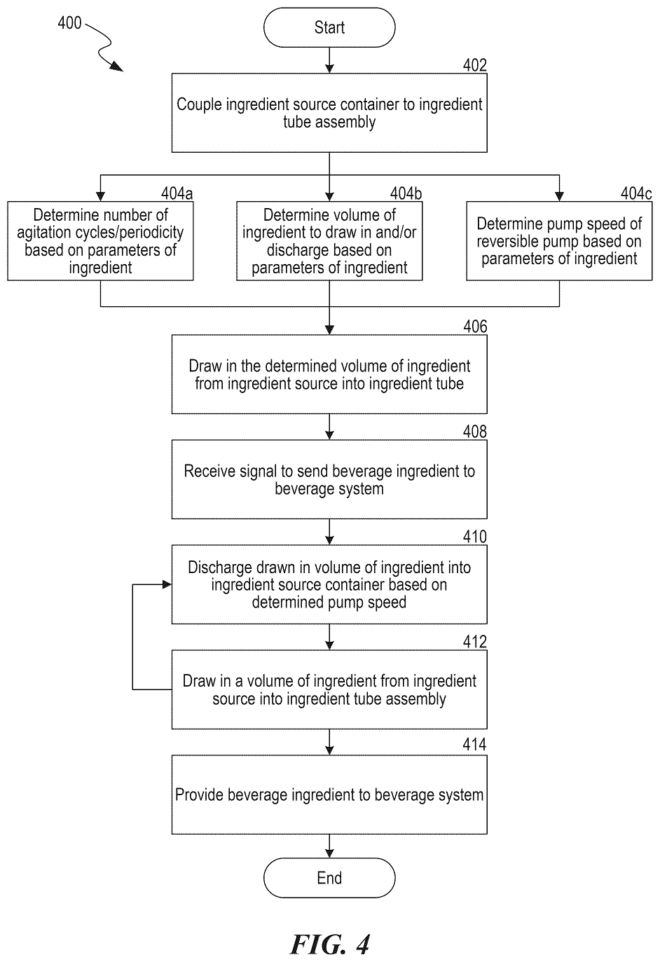

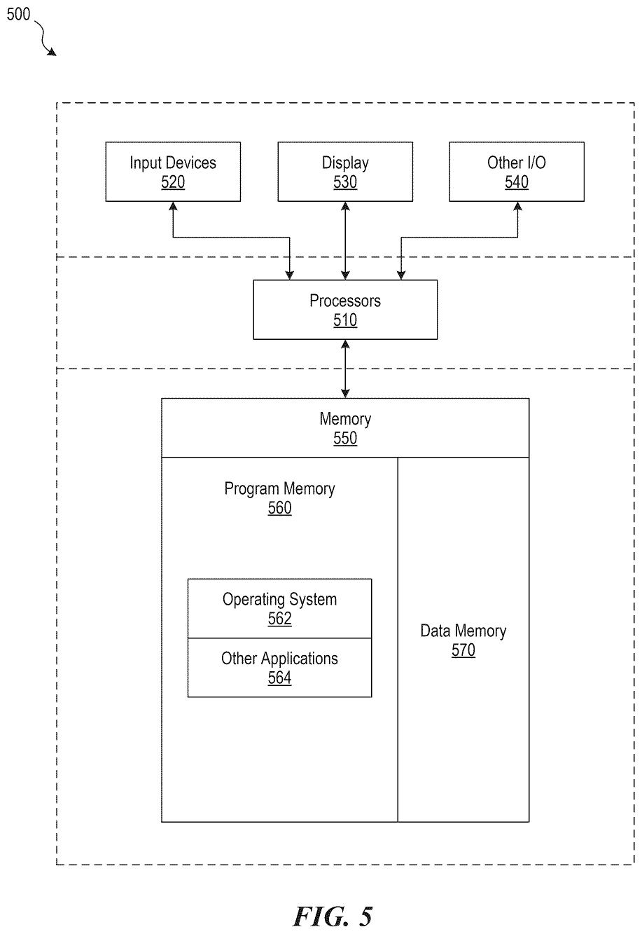

FIG. 4 is a flowchart illustrating a method 400 of agitating beverage ingredients in a beverage ingredient container in accordance with some embodiments of the present technology. In some embodiments, at least some of the blocks of method 400 are performed with agitation systems similar/identical to the agitation systems 200 and 300 described above with reference to FIGS. 2A-2C and 3A-3B, respectively. In some embodiments, at least some of the blocks of method 400 are performed with beverage systems similar/identical to the beverage system 100 described with reference to FIG. 1. In some embodiments, at least some of the blocks of method 400 are performed with a computer system and/or computer operating environment similar/identical to that described with reference to FIGS. 5-7.

At block 402, an ingredient source container (e.g., a BiB, also referred to as a beverage ingredient container) is coupled to an ingredient tube assembly. The ingredient tube assembly comprises a reversible pump, connector tube, and two-way valve. In some embodiments, the ingredient tube assembly is configured to pass (e.g., drive, pump) beverage ingredient from the beverage ingredient container to a beverage system, where the beverage ingredient is mixed/combined with other ingredients and/or dispensed to a user.

Additionally, the ingredient tube assembly is configured to ensure adequate mixing of the beverage ingredient in the beverage ingredient container prior to sending the beverage ingredient to the beverage system. As described further herein, the ingredient tube assembly ensures adequate mixing by drawing in a portion of the beverage ingredient from the beverage ingredient container and discharging the drawn-in portion back into the beverage ingredient container. This cycle agitates the beverage ingredient, causing components of the beverage ingredient that may have separated/stratified (e.g., particles, layers of liquid of varying viscosity, etc.) to mix together. This creates a uniform distribution of particles and other ingredient components throughout the beverage ingredient container.

At block 404a, in some embodiments, a number of agitation cycles (e.g., number of times the portion is drawn in and discharged) and/or a periodicity of agitation (e.g., number of cycles per unit time) is determined. In some embodiments, this determination is based on one or more parameters and/or parameter values of the beverage ingredient, such as the viscosity, particle concentration, beverage type, etc. For example, a beverage ingredient with relatively high viscosity can be correlated to a minimum of three agitation cycles prior to sending to the beverage system, while a beverage ingredient with a relatively low viscosity can be correlated to a single agitation cycle. In some embodiments, the parameters and/or parameter values of the beverage ingredients are stored in a non-volatile memory associated with the agitation system (e.g., in a look-up table). In some embodiments, the parameters and/or parameter values are retrieved from a retrieval feature associated with the beverage ingredient and/or beverage ingredient container, such as a QR code or barcode. At block 404b, in some embodiments, the volume of the portion drawn in and/or discharged is determined. In some embodiments, this determination is based on the one or more parameters and/or parameter values of the beverage ingredient discussed herein. For example, a beverage ingredient with relatively high viscosity can be correlated to a five-ounce portion, while a relatively low viscosity can be correlated to a three-ounce portion. At block 404c, in some embodiments, the pump speed of the reversible pump is determined. In some embodiments, the determination is based on the one or more parameters and/or parameter values discussed herein. For example, a beverage ingredient with a relatively high viscosity can be correlated to a relatively fast discharge speed, while a relatively low viscosity can be correlated to a relatively low discharge speed.

At block 406, the determined volume of the first portion is drawn into the ingredient tube assembly from the beverage ingredient container. In some embodiments, the first portion is driven/pumped into the ingredient tube assembly via operation of the reversible pump. In some embodiments, the first portion is drawn into the tube assembly via other motive forces, such as via vacuum and/or manual filling of the tube assembly by a user.

At block 408, in some embodiments, the agitation system receives a signal to send the beverage ingredient contained in the beverage ingredient container to the beverage system. For example, a controller (e.g., a memory and processor) associated with the agitation system can receive a signal for a beverage to be mixed/produced using the beverage ingredient contained in the beverage ingredient container. The controller can pass an associated signal to components (e.g., the reversible pump) of the agitation system.

At block 410, the first portion of beverage ingredient contained within the ingredient tube assembly is discharged into the beverage ingredient container based on the pump speed determined in block 404c, resulting in mixing of the contents of the beverage ingredient container. In some embodiments, the first portion is discharged in response to the signal received in block 408. In some embodiments, the first portion is discharged in response to the determined periodicity and/or number of agitation cycles determined in block 404a. In some embodiments, the first portion is discharged based on a gravity force on the first portion and/or compressive forces applied from a first reservoir (discussed with reference to FIGS. 3A and 3B).

At block 412, additional volumes (i.e., additional portions) of beverage ingredient are drawn into the tube assembly from the beverage ingredient container. For example, a second portion can be drawn in following discharge of the first portion. In some embodiments, the first portion and the second portion have similar volumes. In some embodiments, the second portion is a different volume from the first portion. For example, based on the determined volume of beverage ingredient to be withdrawn (i.e., the volume of the portion to be withdrawn) for a given agitation cycle, the second portion can be, for example, a smaller volume than the first portion. In some embodiments, blocks 410 and 412 are iteratively repeated based on the determined number of agitation cycles and/or periodicity from block 404a. At block 414, the agitated/mixed beverage ingredient is provided to the beverage system for subsequent mixing and/or dispensing.

### C. COMPUTER SYSTEMS

Several implementations are discussed below in more detail in reference to the figures. FIG. 5 is a block diagram illustrating an overview of devices on which some implementations of the disclosed technology can operate. The devices can include hardware components of a device 500 that execute customized queries created from user selections, of query elements, that are based on metadata from data set registrations. Device 500 can include one or more input devices 520 that provide input to the Processor(s) 510 (e.g., CPU(s), GPU(s), HPU(s), etc.), notifying it of actions. The actions can be mediated by a hardware controller or control circuit that interprets the signals received from the input device and communicates the information to the processors 510 using a communication protocol. Input devices 520 include, for example, a mouse, a keyboard, a touchscreen, an infrared sensor, a touchpad, a wearable input device, a camera-or image-based input device, a microphone, or other user input devices.

Processors 510 can be a single processing unit or multiple processing units in a device or distributed across multiple devices. Processors 510 can be coupled to other hardware devices, for example, with the use of a bus, such as a peripheral component interconnect (PCI) bus or small computer system interface (SCSI) bus. The processors 510 can communicate with a hardware controller or control circuit for devices, such as for a display 530. Display 530 can be used to display text and graphics. In some implementations, display 530 provides graphical and textual visual feedback to a user. In some implementations, display 530 includes the input device as part of the display, such as when the input device is a touchscreen or is equipped with an eye direction monitoring system. In some implementations, the display is separate from the input device. Examples of display devices include a liquid crystal display (LCD) screen, a light emitting diode (LED) screen, a projected, holographic, or augmented reality display (such as a heads-up display device or a head-mounted device), and so on. Other input/output (I/O) devices 540 can also be coupled to the processor, such as a network card, video card, audio card, USB, firewire or other external device, camera, printer, speakers, compact disc read-only memory (CD-ROM) drive, digital versatile disc (DVD) drive, disk drive, or Blu-Ray device.

In some implementations, the device 500 also includes a communication device capable of communicating wirelessly or wire-based with a network node. The communication device can communicate with another device or a server through a network using, for example, transmission control protocol/internet protocol (TCP/IP) protocols. Device 500 can utilize the communication device to distribute operations across multiple network devices.

The processors 510 can have access to a memory 550 in a device or distributed across multiple devices. A memory includes one or more of various hardware devices for volatile and non-volatile storage and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 550 can include program memory 560 that stores programs and software, such as an operating system 562 and other application programs 564. Memory 550 can also include data memory 570, e.g., table data, column data, value filter data, user interface data, database element data, selection data, root table data, code snippet data, join query data, query template data, connection data, configuration data, settings, user options or preferences, etc., which can be provided to the program memory 560 or any element of the device 500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

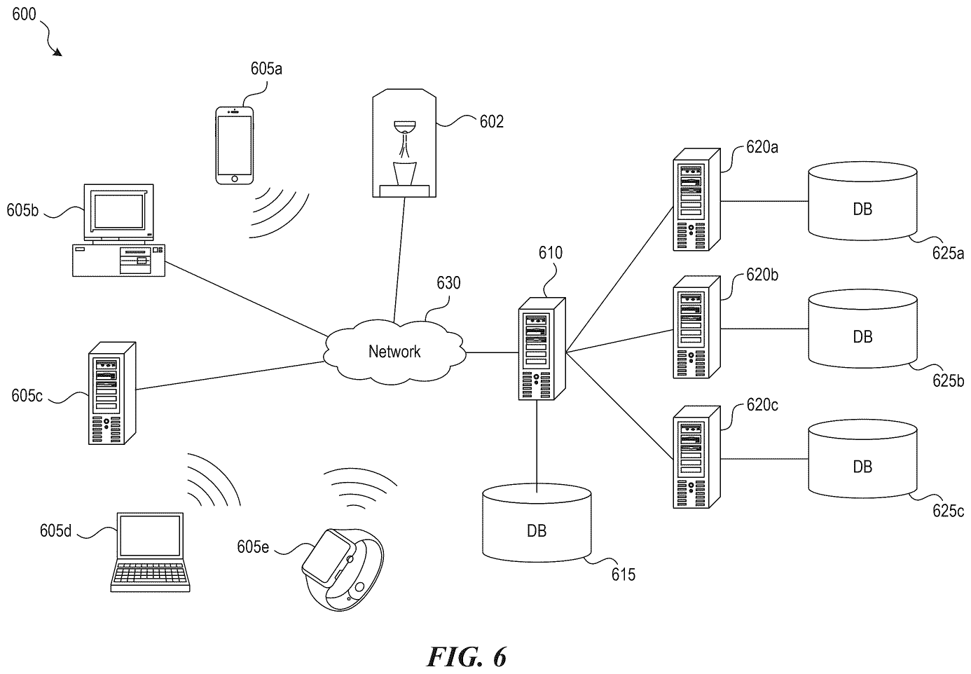

FIG. 6 is a block diagram illustrating an overview of an environment 600 in which some implementations of the disclosed technology can operate. Environment 600 can include one or more client computing devices 605a-e (collectively referred to as “client computing devices 605”) and a beverage system 602. Client computing devices 605 and the beverage system 602 (e.g., system 100 described elsewhere in the present document) can operate in a networked environment using logical connections through network 630 to one or more remote computers, such as a server computing device.

In some implementations, server 610 can be an edge server that receives client requests and coordinates fulfillment of those requests through other servers, such as servers 620a-c. Server computing devices 610 and 620 can include computing systems, such as device 500. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server/client devices. Server 610 can connect to a database 615. Servers 620a-c can each connect to a corresponding database 625a-c. As discussed above, each server 620 can correspond to a group of servers, and each of these servers can share a database or can have their own database. Databases 615 and 625 can warehouse (e.g., store) information such as table data, column data, value filter data, user interface data, database element data, selection data, root table data, code snippet data, join query data, query template data, connection data, etc. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but it can also be other wired or wireless networks. Network 630 may be the Internet, a mobile phone network, a mobile voice or data network (e.g., a 5G or long-term evolution (LTE) network), a cable network, a public switched telephone network, a short-range wireless communication network (e.g., Bluetooth or Near Field Communications (NFC)), or some other public or private network. Client computing devices 605 can be connected to network 630 through a wired or wireless network interface, such as a satellite path, a fiber-optic path, a cable path, a path that supports internet communications (e.g., internet protocol television (IPTV)), free-space connections (e.g., for broadcast or other wireless signals), etc. While the connections between server 610 and servers 620 are shown as separate connections, these connections can be any kind of local, wide area, wired, or wireless network, including network 630 or a separate public or private network. As described in further detail herein, the client computing devices 605 and the beverage system 602 can operate according to an edge computing protocol (e.g., an edge computing decryption protocol).

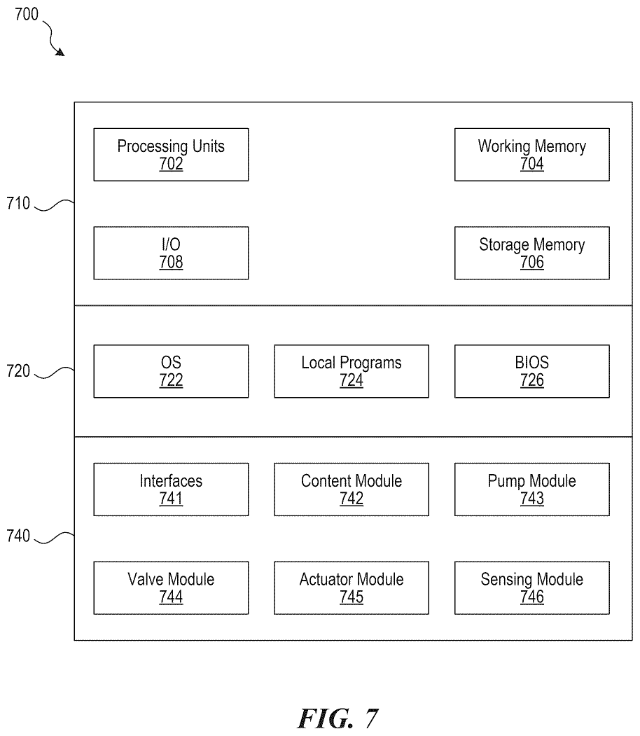

FIG. 7 is a block diagram illustrating components 700, which, in some implementations, can be used in a system employing the disclosed technology. In some implementations, some or all of the components 700 can be included in the beverage system 602 (e.g., the system 100). The components 700 include hardware 710, general software 720, and specialized components 740. The components 700 may correspond to the control 110, as illustrated in FIG. 1.

As discussed above, a system implementing the disclosed technology can use various hardware 710 including processing units 702 (e.g., CPUs, GPUs, accelerated processing units (APUs), etc.), working memory 704, storage memory 706 (local storage or as an interface to remote storage, such as storage 615 or 625), and input and output devices 708. In various implementations, storage memory 706 can be one or more of local devices, interfaces to remote storage devices, or combinations thereof. For example, storage memory 706 can be a set of one or more hard drives (e.g., a redundant array of independent disks (RAID)) accessible through a system bus or can be a cloud storage provider or other network storage accessible via one or more communications networks (e.g., a network accessible storage (NAS) device, such as storage 615 or storage provided through another server 620). Components 700 can include a machine-readable storage medium having machine executable instructions stored thereon. Components 700 can be implemented in a client computing device, such as client computing devices 605, on the beverage system 602, or on a server computing device, such as server computing device 610 or 620.

General software 720 can include various applications including an operating system (OS) 722, local programs 724, and a basic input output system (BIOS) 726.

Specialized components 740 can be subcomponents of a general software application 720, such as local programs 724. Specialized components 740 can include content module 742, pump module 743, valve module 744, actuator module 745, sensing module 746, and components that can be used for providing user interfaces, transferring data, and controlling the specialized components, such as interfaces 741. In some implementations, components 700 can be in a computing system that is distributed across multiple computing devices or can be an interface to a server-based application executing one or more of specialized components 740.

In some implementations, the content module 742 may be configured to manage inventory of one or more fluids, ingredients, and/or cleaning solutions stored in or otherwise accessible to the beverage system 602 and select which content is to be delivered based on an operation to be performed including, e.g., a beverage to be prepared, a cleaning process to be performed, etc. For example, the beverage system 602 can include ingredient sources or containers containing twenty different ingredients, and upon receiving a signal or indication that a specific beverage is desired whose preparation involves two of the twenty ingredients available, the content module 742 can selectively provide those two ingredients. As another example, the content module 742 may monitor inventory, based on which the beverage system 602 may take actions accordingly. For instance, the content module 742 may track the remaining amount of an ingredient, its shelf life, and/or demand based on historical data (e.g., over the past day, week, month, similar season, etc.). Based on the information acquired by the content module 742, the beverage system 602 may provide a reminder for restocking, automatically place an order for restocking, and/or adjust the beverage options available for user selection. For example, the beverage system 602 may remove an option from the menu presented to a user if a needed ingredient is low or out of stock and/or add the beverage option back to the menu when the ingredient is restocked in the beverage system 602.

In some implementations, the pump module 743 may be configured to manage the driving and/or dispensing of liquid-based and/or gas content in the beverage system 602. For example, the pump module 743 may be configured to manage the driving of content received from, e.g., a source or container through the beverage system 602 and dispensing it via one or more openings. For example, the pump module 743 can set the appropriate flow rate, dispensing quantity or volume, pressure, frequency, flow direction, etc., depending on, for example, a desired operation (e.g., a cleaning operation, an operation to produce a selected beverage of a desired temperature), and/or characteristics (e.g., viscosity of the individual ingredient(s)/cleaning solution(s) involved). In some embodiments, the pump module 743 can communicate with other modules, such as the valve module 744 and/or the sensing module 746, to coordinate dispensing of content with one or more desired parameters.

In some implementations, the valve module 744 may be configured to manage the flow of liquid-based and/or gas content in the beverage system 602. For example, the valve module 744 can set the appropriate flow rate, dispensing quantity or volume, pressure, frequency, flow direction, etc., depending on, for example, a desired operation (e.g., a cleaning operation, an operation to produce a selected beverage of a desired temperature). In some embodiments, the valve module 744 can communicate with other modules, such as the pump module 743 and/or the sensing module 746, to coordinate dispensing of content with one or more desired parameters.

In some implementations, the actuator module 745 may be configured to manage the operation of an actuator, motor, pulse generator, etc., in the beverage system 602. For example, the actuator module 745 can set the timing, duration, power, etc., of an actuator or motor, depending on, e.g., a desired operation (e.g., a cleaning operation, a mixing operation, a dispensing operation, a drainage operation). In some embodiments, the actuator module 745 can communicate with other modules, such as the pump module 743 and/or the valve module 744, to coordinate dispensing and mixing of content with one or more desired parameters.

In some implementations, the sensing module 746 may be configured to manage the operation relating to a sensor or sensing circuit in the beverage system 602. For example, the sensing module 746 may manage the operation of a heating element based on temperature of content (e.g., water, a mixture including water) in or exiting a fluid channel in the mixing chamber 190, etc. The sensing module 746 may receive information acquired by a sensor or sensing circuit within or coupled to the beverage system 602, e.g., a temperature sensor or sensing circuit, a pressure sensor or sensing circuit, etc.

Although depicted as separate components, specialized components 740 may be logical or other nonphysical differentiations of functions and/or may be submodules or code-blocks of one or more applications. The components 740 may include or correspond to various controller or control circuits described elsewhere in the present document. Those skilled in the art will appreciate that the components described herein may be altered in a variety of ways.

### D. CONCLUSION

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A beverage ingredient agitation system comprising:
a beverage ingredient container including a volume of at least one beverage ingredient;
an ingredient tube assembly including:
a two-way valve coupling the ingredient tube assembly to the beverage ingredient container, the valve configured to:
accommodate flow of beverage ingredient from the beverage ingredient container to the ingredient tube assembly; and
accommodate flow of beverage ingredient from the ingredient tube assembly to the beverage ingredient container;
a reversible pump configured to drive beverage ingredient flow through the ingredient tube assembly; and
a tube coupling the two-way valve and the reversible pump;
a processor; and
a memory including instructions that, when executed by the processor, cause the ingredient tube assembly to:
draw in a first portion of the volume of the at least one beverage ingredient from the beverage ingredient container; and
discharge, via the reversible pump, the first portion of the volume of the at least one beverage ingredient into the beverage ingredient container.

2. The system of claim 1, further comprising a first fluid reservoir configured to receive a second portion of the volume of the at least one beverage ingredient from the beverage ingredient container, and wherein the memory further includes instructions that, when executed by the processor, cause the ingredient tube assembly to:
draw in the second portion of the volume of the at least one beverage ingredient from the beverage ingredient container; and
discharge, via the reversible pump, the second portion of the volume of the at least one beverage ingredient into the beverage ingredient container.

3. The system of claim 2, wherein the second portion of the volume of the at least one beverage ingredient is greater than the first portion.

4. The system of claim 2, wherein the reversible pump is positioned between the first fluid reservoir and the beverage ingredient container and the first fluid reservoir is positioned at a greater height relative to ground than the reversible pump, such that the second portion of the volume of beverage ingredient contained in the first fluid reservoir flows through the reversible pump and the two-way valve when the ingredient tube assembly is discharging into the beverage ingredient container.

5. The system of claim 2, wherein the first fluid reservoir comprises a flexible material, and wherein the first fluid reservoir is configured to exert a force on the first and second portions of the volume of beverage ingredient such that the first and second portions are driven into the beverage ingredient container when the first fluid reservoir is compressed.

6. The system of claim 2, further comprising a second fluid reservoir configured to receive a third portion of the volume of the at least one beverage ingredient from the beverage ingredient container, and wherein the memory further includes instructions that, when executed by the processor, cause the ingredient tube assembly to:
draw in the third portion of the volume of the at least one beverage ingredient from the beverage ingredient container; and
discharge, via the reversible pump, the third portion of the volume of the at least one beverage ingredient into the beverage ingredient container.

7. The system of claim 1, wherein the memory further includes instructions that, when executed by the processor, cause the ingredient tube assembly to:
receive a signal corresponding to an order to dispense the at least one beverage ingredient contained in the beverage ingredient container; and
in response to the received signal, discharge, via the reversible pump, the first portion of the volume of the at least one beverage ingredient into the beverage ingredient container.

8. The system of claim 1, wherein the memory further includes instructions that, when executed by the processor, cause the ingredient tube assembly to:
periodically draw in and discharge the first portion of the volume of the at least one beverage ingredient.

9. The system of claim 1, wherein the memory further includes instructions that, when executed by the processor, cause the ingredient tube assembly to:
determine one or more parameters of the at least one beverage ingredient;
determine a run time of the reversible pump; and
draw in and discharge the first portion of the volume of the at least one beverage ingredient based on the one or more parameters and the run time of the reversible pump.

10. The system of claim 9, wherein the one or more parameters of the at least one beverage ingredient include one or more of: viscosity, temperature, fruit type, fruit particle concentration, pulp concentration, dairy type, dairy concentration, syrup type, syrup concentration, chemical composition, grain content, fiber content, and beverage ingredient brand.

11. The system of claim 9, wherein the memory further includes instructions that, when executed by the processor, cause the ingredient tube assembly to:
modify a pump speed of the reversible pump based on the one or more parameters.

12. The system of claim 9, wherein the memory further includes instructions that, when executed by the processor, cause the ingredient tube assembly to:
modify the volume of the first portion based on the one or more parameters.

13. A method of agitating a volume of beverage ingredient in a beverage ingredient container, the method comprising:
drawing a first portion of a volume of at least one beverage ingredient contained in the beverage ingredient container into a tube assembly, the tube assembly including a two-way valve, a reversible pump, and a tube coupling the two-way valve to the reversible pump; and
discharging, via the reversible pump, the first portion of the volume of the at least one beverage ingredient into the beverage ingredient container.

14. The method of claim 13, further comprising:
drawing in a second portion of the volume of the at least one beverage ingredient from the beverage ingredient container into a first reservoir of the tube assembly after drawing in the first portion; and
discharging, via the reversible pump, the second portion of the volume of the at least one beverage ingredient into the beverage ingredient container after discharging the first portion.

15. The method of claim 13, further comprising:
receiving a signal corresponding to an order to dispense the at least one beverage ingredient contained in the beverage ingredient container; and
discharging, in response to the received signal, via the reversible pump, the first portion of the volume of the at least one beverage ingredient into the beverage ingredient container.

16. The method of claim 13, further comprising:
periodically drawing in and discharging the first portion of the volume of the at least one beverage ingredient.

17. The method of claim 13, further comprising:
determining one or more parameters of the at least one beverage ingredient;
determining a run time of the reversible pump;
drawing in the first portion of the volume of the at least one beverage ingredient based on the one or more parameters and the run time of the reversible pump; and
discharging the first portion of the volume of the at least one beverage ingredient based on the one or more parameters and the run time of the reversible pump.

18. The method of claim 17, further comprising:
modifying a pump speed of the reversible pump based on the one or more parameters; and
modifying the volume of the first portion based on the one or more parameters.

19. A tube assembly for use with a bag-in-box beverage ingredient container, the assembly comprising:
a valve coupling the tube assembly to the bag-in-box beverage ingredient container, the valve configured to:
accommodate flow of beverage ingredient from the bag-in-box beverage ingredient container to the tube assembly; and
accommodate flow of beverage ingredient from the tube assembly to the bag-in-box beverage ingredient container;
a pump configured to drive beverage ingredient flow through the tube assembly; and
a tube coupling the valve to the pump;
wherein the tube assembly is configured to receive a first portion of a volume of at least one beverage ingredient from the bag-in-box beverage ingredient container.

20. The assembly of claim 19, further comprising a first fluid reservoir configured to receive a second portion of the volume of the at least one beverage ingredient from the bag-in-box beverage ingredient container, and wherein the pump is positioned between the first fluid reservoir and the bag-in-box beverage ingredient container and the first fluid reservoir is positioned at a greater height relative to ground than the pump.
